(19) United States
(12) Patent Application Publication
(10) Pub. No.: US 2026/0220166 A1
(43) Pub. Date: Jul. 30, 2026

(54) SYSTEMS AND METHODS FOR VERIFYING TEXT-GENERATING NEURAL NETWORK MODELS

(71) Applicant: Salesforce, Inc., San Francisco, CA (US)

(72) Inventors: James Zhu, San Francisco, CA (US); Shivansh Chaudhary, Seattle, WA (US); Shubham Mehrotra, Santa Clara, CA (US); Bin Bi, Bellevue, WA (US); Sitaram Asur, Newark, CA (US); Neethu Renjith Gerard, San Francisco, CA (US); Feifei Jiang, San Francisco, CA (US)

(21) Appl. No.: 19/392,795

(22) Filed: Nov. 18, 2025

Related U.S. Application Data
(63) Continuation-in-part of application No. 19/037,931, filed on Jan. 27, 2025.

(51) Int. Cl. G06F 16/332

(52) U.S. Cl. CPC G06F 16/3326

(57) ABSTRACT

Embodiments described herein provide a method of configuring an artificial intelligence (AI) agent to respond to a user query. The method includes: receiving a user query; generating, by a first neural network based language model, a response to the user query; generating, by the first neural network based language model, a summary of an interaction history; and training, a second neural network based language model, using a dataset including the summary and the interaction history to generate a rating of the summary, an explanation of the rating, and a citation in the interaction history supporting the explanation conditioned on the summary and the interaction history in response to a training query. The method also includes: building, at a server, the AI agent through a first application programming interface (API) to the first neural network based language model and a second API to the trained second neural network based language model.

### CROSS REFERENCE(S)

The instant application is a continuation-in-part of U.S. application Ser. No. 19/037,931, titled “SYSTEMS AND METHODS FOR VERIFYING TEXT-GENERATING NEURAL NETWORK MODELS”, filed Jan. 27, 2025, which is incorporated by reference herein in its entirety.

### TECHNICAL FIELD

The embodiments relate generally to machine learning systems for natural language text generation, and more specifically to systems and methods for verifying text-generating neural network models.

### BACKGROUND

AI conversation agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, texts generated by these AI agents may contain factual inaccuracies and hallucinations, and thus cause risks in practical applications, e.g., dissemination of misinformation, false diagnostics, and/or the like.

### BRIEF DESCRIPTION OF THE DRAWINGS

FIG. 1 illustrates an application of an agent verification framework, according to some embodiments.

FIG. 2 is a simplified diagram illustrating an agent verification framework according to some embodiments.

FIGS. 3A and 3B show an exemplary operation by an agent verification framework, according to some embodiments.

FIG. 3C show two exemplary operations by an agent verification framework, according to some embodiments.

FIG. 4A is a simplified diagram illustrating a computing device implementing the agent verification framework described in FIGS. 1, 2, and 3A-3C, according to some embodiments.

FIG. 4B is a simplified diagram illustrating a neural network structure, according to some embodiments.

FIG. 5 is a simplified block diagram of a networked system suitable for implementing the agent verification framework described in FIGS. 1, 2, 3A-3C, 4A, and 4B, and other embodiments described herein.

FIG. 6 is an example logic flow diagram illustrating a method of agent evaluation based on the framework shown in FIGS. 1, 2, 3A-3C, 4A, 4B, and 5 according to some embodiments.

FIGS. 7A-7F provide charts illustrating exemplary performance of different embodiments described herein.

FIGS. 8A and 8B show evaluation metrics and certain criteria associated with the evaluation metrics, according to some embodiments.

FIG. 9 is an example logic flow diagram illustrating a method of agent evaluation based on the framework shown in FIGS. 1, 2, 3A-3C, 4A, 4B, 5, 8A, and 8B according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

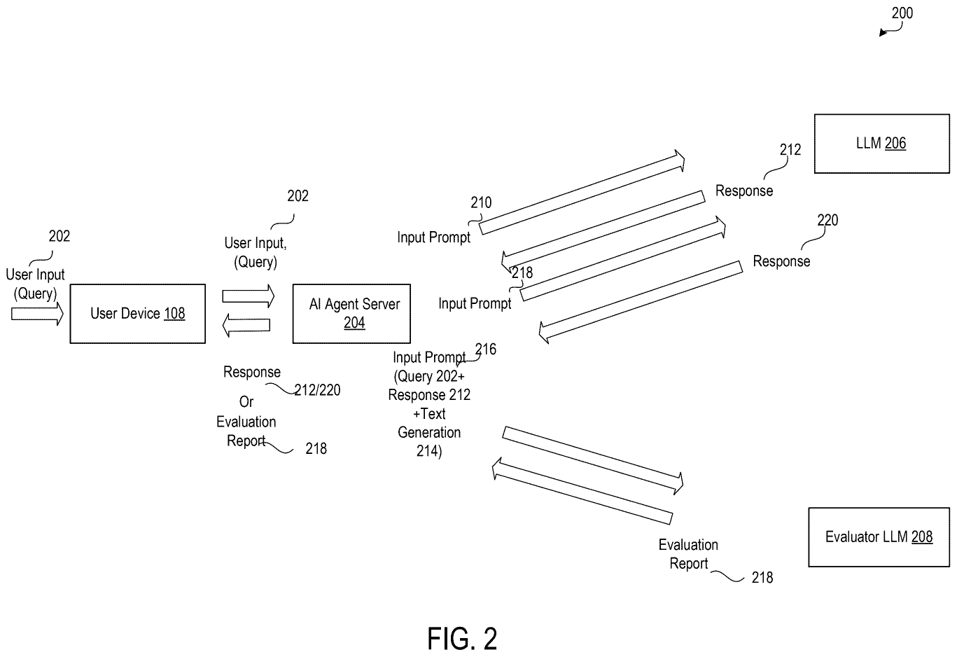

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 2, and 3A-3C.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, an application programming interface (API) call may refer to an interaction between a software application to an API to retrieve or send data, or perform a specific action. In an example, an API call may include a request sent by the software program and a response received by the software program through the API. As used herein, a single API call may include a single request sent by the software program and a single response received by the software program through the API.

### Overview

Large language model (LLM) can be used for generating answers to queries. However, texts generated by these LLMs may contain factual inaccuracies and hallucinations, and thus cause risks in practical applications, e.g., dissemination of misinformation, false diagnostics, and/or the like. Conventionally, agent verification systems reused the same LLM for both text generation and evaluation, introducing evaluation bias due to shared reasoning paths and linguistic preferences.

In view of the need for AI-generated text with higher factual accuracy and less hallucinations, embodiments of the present disclosure provide an verification framework that validates an output generated by a text-generating LLM. For example, an evaluator LLM may receive the output of the text-generating LLM, context of the output, and the prompt that causes the text-generating LLM to generate the output. The evaluator LLM may generate a rating of the output based on a predetermined metric, an explanation for the rating, and a citation referring to specific parts of the context as an evidence for the rating and/or explanation in a single application programming interface (API) call.

The agent verification framework of the disclosure may include an agent (e.g., text-generating) LLM that executes user tasks and a separate guardrails (evaluator) LLM which evaluates outputs using structured reasoning. The framework may operate a feedback-driven reflection loop that continuously updates the agent LLM's behavior, input prompts, and configuration until the output meets enterprise-grade criteria for factuality, policy compliance, completeness, and task resolution, etc. The framework may improve unbiased evaluation by decoupling the evaluator from the generation model, addressing shortcomings in existing technology in which evaluator LLM and the text-generating LLM are integrated in one LLM.

Embodiments described herein provide a number of benefits. For example, developer of the text-generating LLM can have better knowledge of the capability of the text-generating LLM, and can improve the instructions to the text-generating LLM to generate improved output (e.g., with higher accuracy and less hallucinations). Therefore, with improved performance on text generation, neural network technology in applications using artificial intelligence (AI) agents based on text-generating LLMs (e.g., healthcare, network issue diagnostics) is improved.

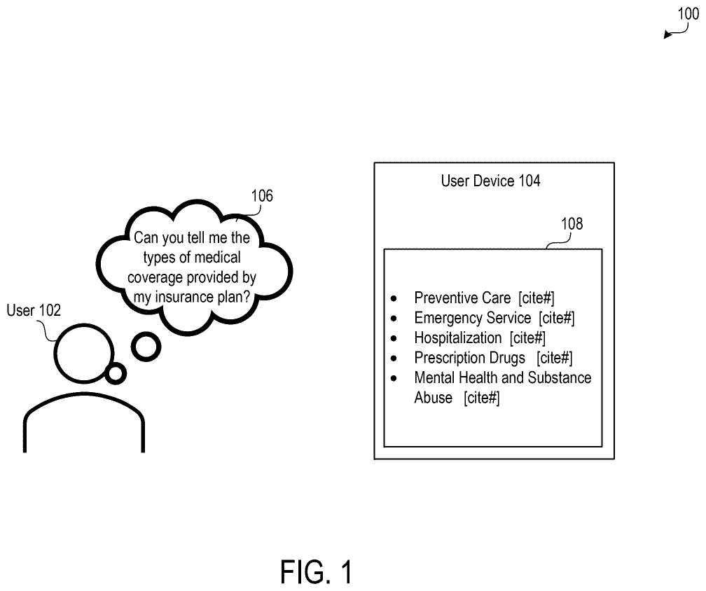

FIG. 1 shows an application 100 of an LLM based AI conversation agent, according to embodiments of the present disclosure. A user 102 may utter a query 106 in natural language. In response, a user device 104 may output/display an answer 108 on a display interface, such as a screen. In some embodiments, answer 108 is the output of an AI agent, which is built on a AI agent server that is communicatively connected to user device 104. The chatbot may be based on, or include, an LLM. In some embodiments, the LLM receives query 106 through utterance of user 102, which may retrieve a corpus of documents (or knowledge), and generate an output based on the retrieved documents/knowledge.

As an example, query 106 may include a question of “Can you tell me the types of medical coverage provided by my insurance plan?” The AI agent may include the query 106 in a predefined format providing instruction to the LLM how to generate a response to query 106, referred to as a “prompt,” which may be fed to an LLM as input. The LLM may in turn provide answer 108, e.g., a summary of the types of medical coverages in a predetermined format, e.g., a bullet-point format, such that one type of medical coverage is listed behind a bullet-point. In some aspects, for example, a citation of document(s) that mentioned the medical coverage is provided behind the respective bullet.

The underlying LLM may be implemented at user device 104, and/or at a remote server which is accessible by the user device 104. The LLM may be trained with a large corpus of texts and/or documents to provide a user desirable response as further described in FIG. 2 below.

FIG. 2 shows an exemplary agent verification framework 200, according to some embodiments. Agent verification framework 200 may include user device 108, an AI agent server 204, a LLM 206, and an evaluator LLM 208. LLM 206 may include a text-generating LLM, and evaluator LLM 208 may be configured to evaluate the text generated by LLM 206. AI agent server 204 may be communicatively connected to user device 108. AI agent server 204 may also be communicatively connected to LLM 206 and evaluator LLM 208 via respective APIs. In some embodiments, AI agent server 204 may include an AI agent that respond to a user query with response 212.

User device 108 may be installed with an API, and may be communicatively connected to AI agent server 204 through the API. At inference stage, user device 108 may receive a user input 202 from a user's utterance, and may transmit user input 202 to AI agent server 204 through the API. In some embodiments, user input 202 includes a query such as query 106.

AI agent server 204 may receive user input 202 and may generate an input prompt 210 as an output based on the query. Input prompt 210 may include the query and an instruction that causes LLM 206 to generate an response 212 to the query. LLM 206 may receive input prompt 210 as an input and generate an output that includes response 212. For example, response 212 may be similar to answer 108. LLM 206 may transmit response 212 to AI agent server 204 through the API. In some embodiments, LLM 206 represents an AI agent, and user query represents a query sent by a customer. In some embodiments, LLM 206 includes a suitable neural network based language model such as GPT-3.5, GPT-4o, etc. In some embodiments, AI agent server 204 may transmit response 212 to user device 108 for the use's view.

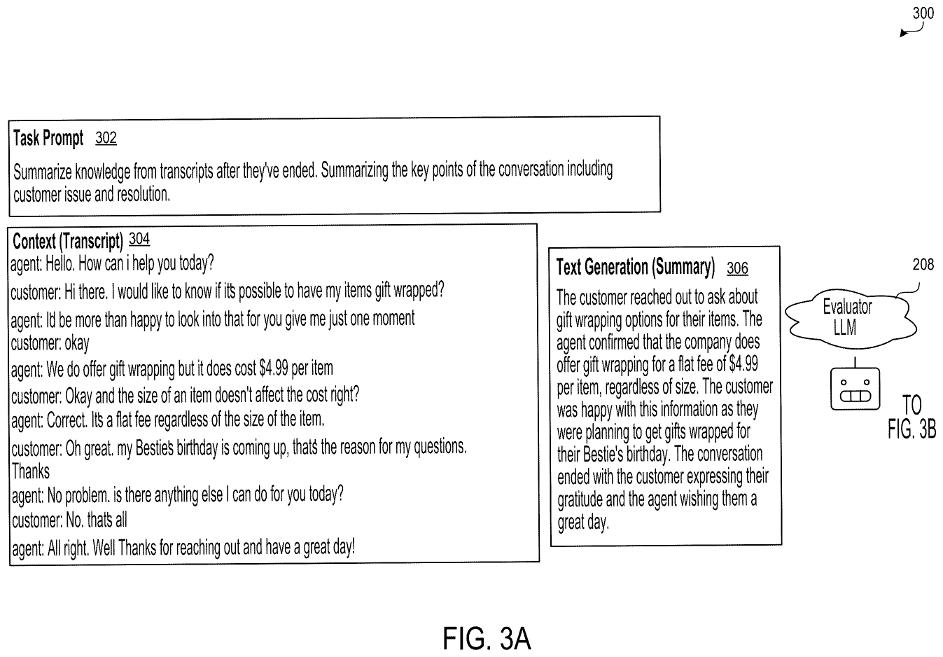

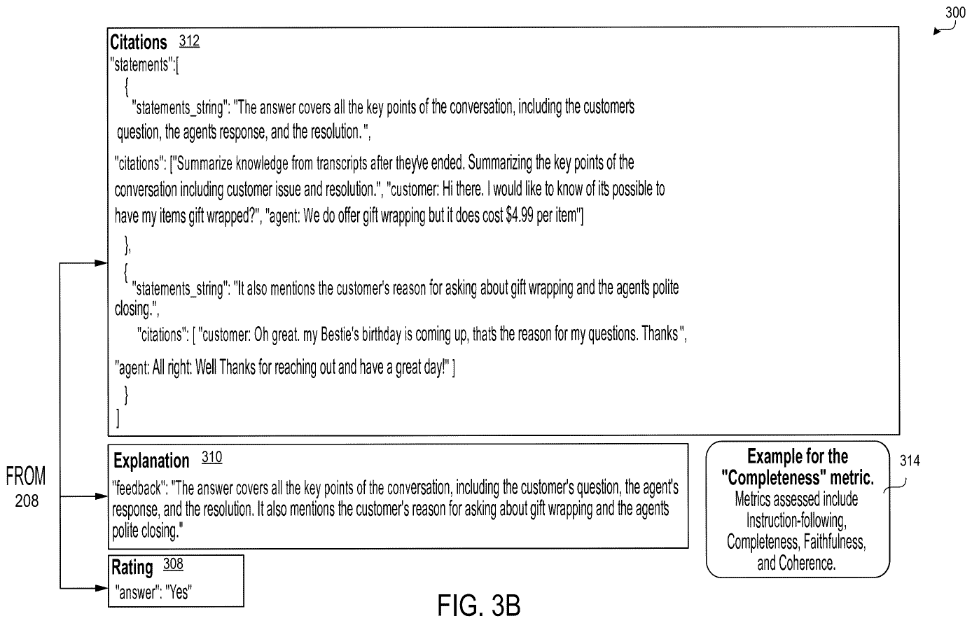

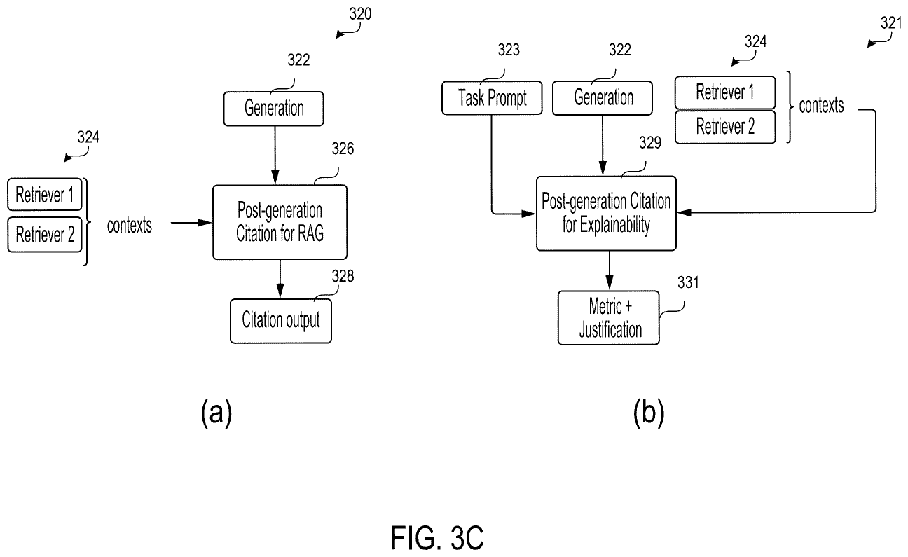

In some embodiments, input prompt 210 includes an instruction that causes LLM 206 to generate a text generation associated with the context or interaction between AI agent server 204 and LLM 206. The interaction may include a transcript or context of the conversations between AI agent server 204 (representing “customer”) and LLM 206 (representing “agent”). In some embodiments, a transcript/context has its unique identification (ID) number. LLM 206, upon receiving the instruction, may generate response 212 with a text generation 214 of the interaction. In some embodiments, text generation 214 includes a summary of the interaction. FIGS. 3A and 3B show an agent verification process 300 by agent verification framework 200, according to some embodiments. FIG. 3B is a continuation of FIG. 3A. “Task Prompt” 302 may be an example of the instruction that causes LLM 206 to generate a text generation 306 (e.g., a summary); “Context(Transcript)” 304 may be an example of the interaction between “agent” and “customer”; and “Text Generation (Summary)” 306 may be an example of text generation 214 as part of response 212 and may include a summary of Context (Transcript) 304. Context(Transcript) 304 may include queries (e.g., user input 202) from a customer and responses 212 by an agent (e.g., LLM 206). In some embodiments, AI agent server 204 causes LLM 206 to generate text generation 214 (e.g., a summary) periodically or based on a predetermined setting. For example, AI agent server 204 can cause LLM 206 to generate text generation 214 automatically and without receiving a command in user input 202.

Upon receiving response 212, AI agent server 204 may generate an input prompt 216 that may cause evaluator LLM 208 to evaluate response 212. Input prompt 216 may combine context (e.g., 304) of the interaction between AI agent server 204 and LLM 206, and text generation 214 (e.g., 306) of the context. In some embodiments, the context also includes the query in user input 202 and response 212. Input prompt 216 may also include an instruction that causes evaluator LLM 208 to generate an output that includes an evaluation report 218 in a specific format and/or mode. AI agent server 204 may transmit input prompt 218 to evaluator LLM 208 via an API. Upon receiving input prompt 216, evaluator LLM 208 may generate evaluation report 218 that includes a rating of text generation 214, an explanation of the rating, one or more citations supporting the explanation and/or rating, and/or a set of metrics used to generate the rating, explanation, and/or the citations. The citations may be included in a specific format/mode as instructed by input prompt 216, and may include sentences from the context that directly support each sentence in the explanation. Evaluator LLM 208 may generate the rating, the explanation, and the citations in a single API call. For example, the rating, the explanation, and the citations may be generated in a predefined sequence, and may be transmitted to AI agent server 204 in a single API call. In some embodiments, evaluator LLM 208 includes a general-purpose LLM such as GPT-3.5, GPT-4, GPT-4o, Mistral, Llama, Claude, REC, etc.

In various embodiments, the format/mode for the citations may include a post-fix citation mode, a post-fix citation mode with snippet, an inline citation mode, and an inline citation mode with snippet. In the post-fix citation mode, if the generation (e.g., text of the explanation) is few sentences long, the citation is placed at the end of the response and is referred to the context ID number (ID). In the post-fix citation mode with snippet, if the generation is few sentences long, the citation is placed at the end of the response and is referred to the exact sentence within that context that supports the generation. In the inline citation mode, if the generation is long, the citation is placed at appropriate locations within the generation and is referred to the context ID. In the inline citation mode with snippet, if the generation is long, the citation is placed at appropriate locations within the generation and is referred to the exact sentence within that context that supports the generation.

These different modes of citations were designed to cater to different trade-offs between latency and granularity of citation. For instance, the post-fix citation mode may be the fastest as there is no need for evaluator LLM 208 to generate snippet. It simply has to generate the reference to the cited context. On the other hand, the inline citation mode with snippet may include placing the citation inline with the generated response and also point to a snippet within the corresponding cited context. This mode may be most granular but can also increase latency as it needs to generate more output tokens.

The metrics used by evaluator LLM 208 may include faithfulness, instruction following, coherence, completeness, and citations in an evaluation report with a rating and an explanation. The faithfulness metric may refer to the level by which LLM 206 generates factually correct response given the context. The instruction following metric may refer to the level by which LLM 206 generates response that follows the instructions provided in the input prompt (e.g., 216). The coherence metric may refer to the level by which LLM 206 generates a coherent response. The completeness metric may refer to the level by which LLM 206 generates a complete response including all details. The citation metric may refer to the level by which LLM 206 generates factually correct response and provides evidence for where the response came from.

FIG. 3B shows an example of an evaluation report that includes a rating 308, an explanation 310, a set 312 of citations, and a set 314 of metrics. As an example, FIG. 3B shows a post-fix citation mode with snippet.

Compared to previous evaluation frameworks that focus on providing rating and explanation in automatic evaluation or require iterative prompting to generate citations, agent verification framework 100 may generate a rating, an explanation, and a citation in a single API call. Agent verification framework 200 is the first to enable citation in both automatic evaluation and general task output with scalability and efficiency.

Referring back to FIG. 2, upon receiving evaluation report 218, AI agent server 204 may transmit evaluation report 218 to user device 108 for the user's view. In some embodiments, AI agent server 204 receives evaluation report 218 (including the rating, the explanation, the citations, and/or metrics) in a single API call. In some embodiments, AI agent server 204 automatically uses evaluation report 218 to improve the instruction to LLM 206 for future generations such that the rating in the evaluation report can be improved/increased. As shown in FIG. 2, AI agent server 204 may generate an input prompt 218 that includes user input 202 and an updated/refined instruction. AI agent server 204 may be configured to generate the update instruction based on one or more of the rating, the explanation, the citations, and the metrics. The updated instruction can cause LLM 206 to generate an response 220 that has a higher rating, an improved explanation, and/or citations with higher accuracy. AI agent server 204 may receive response 220 from LLM 206, and may further transmit response 220 to user device 108 for the user's view.

Prior to inference, evaluator LLM 208 may be trained/finetuned with a training dataset. The training dataset may include public data and/or synthetic data generated by another LLM (or data LLM for ease of description). The data LLM may be provided with an input prompt that includes a source text (e.g., context), an answer provided by another LLM (e.g., response 212), and an instruction that cause the data LLM to generate an evaluation report. The instruction may include evaluation criteria such as metric(s) used for evaluation, evaluation steps, answer and a response. In some embodiments, the instruction may cause the data LLM to generate citations in a predetermined format/mode. The data LLM may then generate one or more reference evaluation reports. In some embodiments, a labeling LLM (e.g., a same data LLM or a different LLM from the data LLM) is used to label the reference evaluation. For example, an evaluation report may be labeled based on metrics such as faithfulness, instruction following, coherence, and/or citation. The labeling LLM may be provided with instructions to label “yes” or “no” of a reference evaluation report based on certain criteria. The labeled reference evaluation report may be used in a supervised learning for training/finetuning evaluator LLM 208. In some embodiments, data LLM includes Mistral, Llama, etc.

During training/finetuning, evaluator LLM 208 may receive an input that includes a context (e.g., including a query and a response), a text generation, and an instruction that causes evaluator LLM 208 to generate an output that includes an evaluation report. The evaluation report generated by evaluator LLM 208 may be compared with the labeled reference evaluation report to minimize a training objective, such as a loss. Parameters of evaluator LLM 208 may be updated, e.g., through back propagation. In some embodiments, context includes retrieval-augmented generation (RAG).

In various embodiments, public data and/or synthetic data are used to train evaluator LLM 208 for various evaluation tasks such as pairwise evaluation, pointwise evaluation, open-ended evaluation, citation, and general instruction. In pairwise evaluation, evaluator LLM 208 may learn to compare two responses at the same time and express a preference according to evaluation criteria. In pointwise evaluation, evaluator LLM 208 may learn to evaluate specific aspects of a response independently according to evaluation criteria and provide a rating. In open-ended evaluation, evaluator LLM 208 may learn to evaluate a response independently and provide a free-form explanation, often to support either pairwise or pointwise evaluation. In citation, evaluator LLM 208 may learn to evaluate a response alongside the context, and provide citations for verifiable answer attribution. In general instruction, evaluator LLM 208 may learn to generate a response as instructed (no evaluation tasks in this type), such as summarization and question-and-answer (QA). In some embodiments, synthetic data is generated for pointwise evaluation and citation.

In some embodiments, evaluation report 218 includes a low rating (e.g., a rating lower than a predetermined value), and AI agent server 204 deletes response 220. In some embodiments, AI agent 204 sends a prompt/request to a user interface widget as part of or coupled to user device 108 to ask the user to “accept” or “reject” a response that has a low rating.

FIG. 3C shows two different applications of agent verification framework 200 used for evaluating text generation based on retrieval-augmented generation (RAG), according to some embodiments. In the two applications, RAG may be used as context(s).

FIG. 3C(a) shows an application 320 in which agent verification framework 200 generates an evaluation report with citations based on RAG. As shown in FIG. 3C(a), agent verification framework 200 may receive generation 322 (e.g., a response/text generated by a text-generating LLM) and contexts 324 (e.g., retrieval results/chunks by one or more retrievers such as retrievers 1 and 2). Agent verification framework 200 may perform a post-generation citation for RAG 326 to generate an evaluation report such as a citation output 328. In citation output 328, agent verification framework 200 may cite from the retrieved results/chunks (contexts) and tag the citations with generation 322. For example, generation 322 may include [part 1, part 2, part 3, . . . ], and citation output 328 may include [part 1[c1][c2], part 2[c3], part 3[c4], . . . ] with JavaScript Object Notation (JSON) for citations [c1][c2][c3][c4].

FIG. 3C(b) shows an application 321 in which agent verification framework 200 generates an evaluation report with rating, explanation, and citations. As shown in FIG. 3C(b), agent verification framework 200 may receive generation 322, contexts 324, and a task prompt 323 as inputs. In some embodiments, task prompt 323 includes an instruction that causes the text-generating LLM to generate generation 322. Agent verification framework 200 may perform a post-generation citation for explainability 329, and generate an evaluation report such as a metric and justification 331 as an output. Metric and justification 331 may include a rating of generation 322, an explanation of the rating, and citations from contexts 324 to support the rating and/or explanation. For example, the metric part may include a rating and an explanation, and the justification part may include [justification part 1[c1][c2], justification part 2[c3], . . . ] with JSON for citations [c1][c2][c3].

The present disclosure provides a novel general-purpose LLM autoevaluator (e.g., evaluator LLM 208) that comes in two sizes: 12B and 70B, that can generate better quality Rating, Explanation and Citations (REC), with little to no trade-off in general instruction task performance evaluated on various public benchmark datasets and our own dataset described below. The present disclosure also provides a curated dataset for citations and explanations fine-tuning to facilitate future research, which is the first public dataset containing both content quality citations and RAG citations. The present disclosure further provides a single model that can perform different modes of citation to cover the tradeoff between latency and granularity of citation. Such model with generalized capability largely simplify the deployment complexity in production.

### Computer and Network Environment

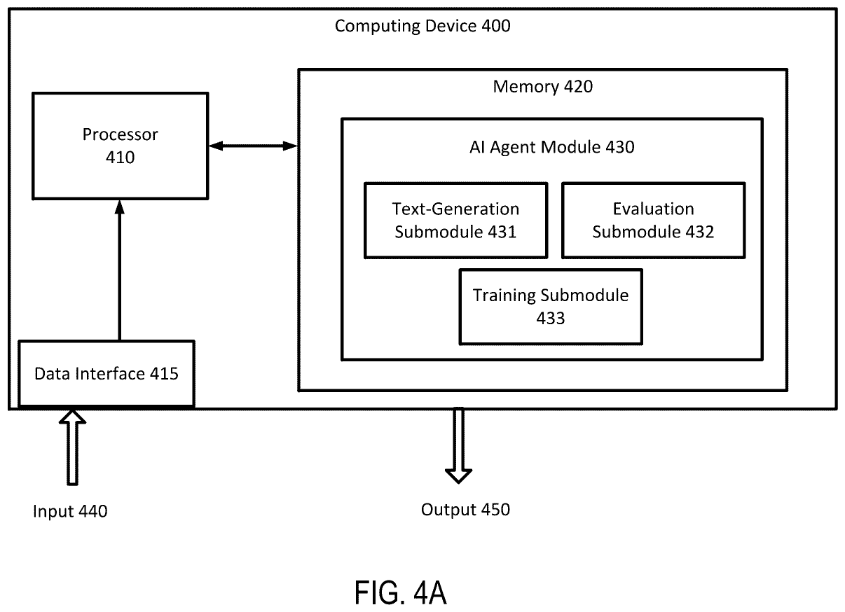

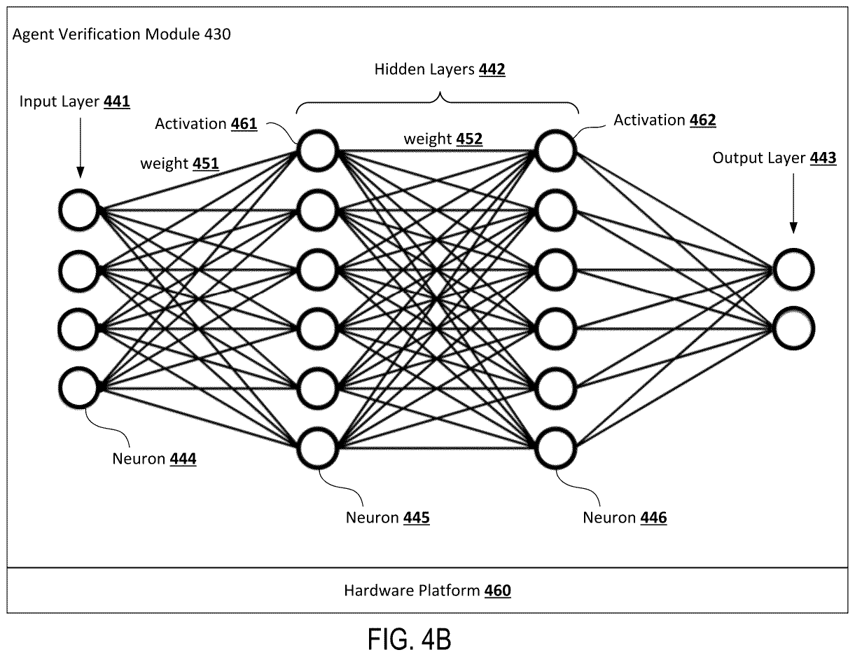

FIG. 4A is a simplified diagram illustrating a computing device implementing the agent verification framework 200 described in FIGS. 1, 2, and 3A-3C, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI agent module 430 that may be used to implement and/or emulate the systems and models, and/or to implement any of the methods described further herein. AI agent module 430 may receive input 440 such as an input training data (e.g., text generated by a text-generating LLM, contexts, optional task prompt, and/or a reference evaluation report) via the data interface 415 and generate an output 450 which may be an output evaluation report.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a user query for inference, and/or text generated by a text-generating LLM, contexts, optional task prompt, and/or a reference evaluation report for training, from a user via the user interface.

In some embodiments, the AI agent module 430 is configured to answer a user query and evaluate a response associated with the answer. The AI agent module 430 may further include a text-generation submodule 431, an evaluation submodule 432, and a training submodule 433. Submodules 431-433 may perform similar operations as AI agent server 204 in FIG. 2. Text generation submodule 431 may be configured to generate an input prompt (e.g., 210) upon receiving a user query (e.g., 202). The input prompt may cause a text-generating LLM (e.g., LLM 206) to generate an answer (e.g., 212) to the user query, and generate a response associated with the answer, e.g., a summary of the interaction between the user and the text-generating LLM (including the user query and the answer). Evaluation submodule 432 may be configured to generate an input prompt (e.g., 216) that may cause an evaluator LLM (e.g., 208) to generate an evaluation report (e.g., 218) in a single API call. The text-generation submodule 431 may also be configured to generate an updated input prompt (e.g., 218) to the text-generating LLM based on the evaluation report. In some embodiments, the updated input prompt causes LLM 206 to generate an answer with improved metrics that are included in the evaluation report. Training submodule 433 may be configured to generate input prompts that may cause a data LLM to generate reference evaluation reports as part of the training data, and may train the evaluator LLM using the training data.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the AI agent module 430 described in FIG. 4A, according to some embodiments. In some embodiments, the AI agent module 430 and/or one or more of its submodules 431-433 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a user query for inference, and/or text generated by a text-generating LLM, contexts, optional task prompt, and/or a reference evaluation report for training. The number of nodes (neurons) in the input layer 441 may be determined by the dimensionality of the input data (e.g., the length of a vector of a user query for inference, and/or text generated by a text-generating LLM, contexts, optional task prompt, and/or a reference evaluation report for training). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the AI agent module 430 receives an input 440 of a user query for inference, and/or text generated by a text-generating LLM, contexts, optional task prompt, and/or a reference evaluation report for training and transforms the input into an output 450 of an answer to the user query at inference, and/or an evaluation report at training. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 430 and/or one or more of its submodules 431-433 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be Mistral-7B, Llama-3.1-70B, Claude-3-Opus, GPT-3.5, GPT-4, GPT-4o, REC-12B, REC-70B, and/or the like.

In one embodiment, the AI agent module 430 and its submodules 431-433 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of the ANN that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the AI agent module 430 and its submodules 431-433 may be implemented by hardware, software and/or a combination thereof. For example, the AI agent module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In another embodiment, some or all of layers 441, 442, 443 and/or neurons 442, 445, 446, and operations there between such as activations 461, 462, and/or the like, of the AI agent module 430 and its submodules 431-433 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI agent module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI agent module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on a loss. For example, during forward propagation, the training data such as a user query for inference, and/or text generated by a text-generating LLM, contexts, optional task prompt, and/or a reference evaluation report for training are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding reference evaluation reports that are labeled as “correct”) from the training data, to compute a loss function that measures the discrepancy between the predicted output and the expected output. For example, the loss function may be cross entropy, minimum mean square error (MMSE), or a combination thereof. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based AI agent module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

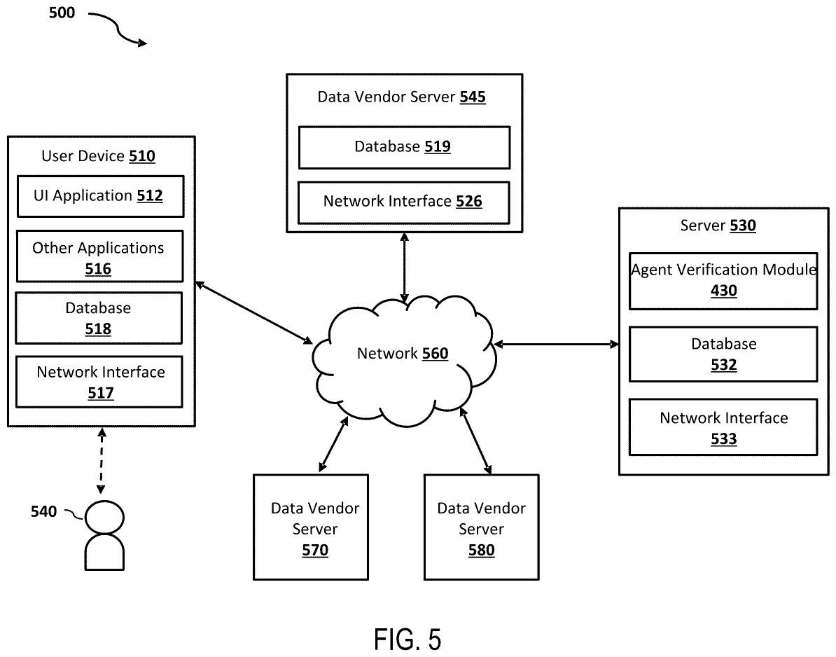

In some embodiments, AI agent module 430 and its submodules 431-433 may be housed at a centralized server (e.g., computing device 400) or one or more distributed servers. For example, one or more of AI agent module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 5.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as answering a user query, and evaluating the answer.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in text generation.

FIG. 5 is a simplified block diagram of a networked system 500 suitable for implementing the agent verification framework described in FIGS. 1, 2, 3A-3C, 4A, and 4B and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating a user query from the server 530 and display the message via the UI application 512. In other embodiments, user device 510 may include additional or different modules having specialized hardware and/or software as required.

In one embodiment, UI application 512 may communicatively and interactively generate a UI for an AI agent implemented through the AI agent module 430 (e.g., an LLM agent) at server 530. In at least one embodiment, a user operating user device 510 may enter a user utterance, e.g., via text or audio input, such as a question, uploading a document, and/or the like via the UI application 512. Such user utterance may be sent to server 530, at which AI agent module 430 may generate a response via the process described in FIGS. 1, 2, 3A-3C, 4A, and 4B. The AI agent module 430 may thus cause a display of answer (e.g., 212 and/or 220) at UI application 512 and interactively update the display in real time with the user utterance.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view an answer, and optionally, an evaluation report.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including text generated by a text-generating LLM, contexts, optional task prompt, and/or a reference evaluation report to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the AI agent module 430 and its submodules described in FIG. 4A. In some implementations, AI agent module 430 may receive data from database 519 at the data vendor server 545 via the network 560 to generate an evaluation report. The generated evaluation report may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the AI agent module 430. In one implementation, the database 532 may store previously generated evaluation reports, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

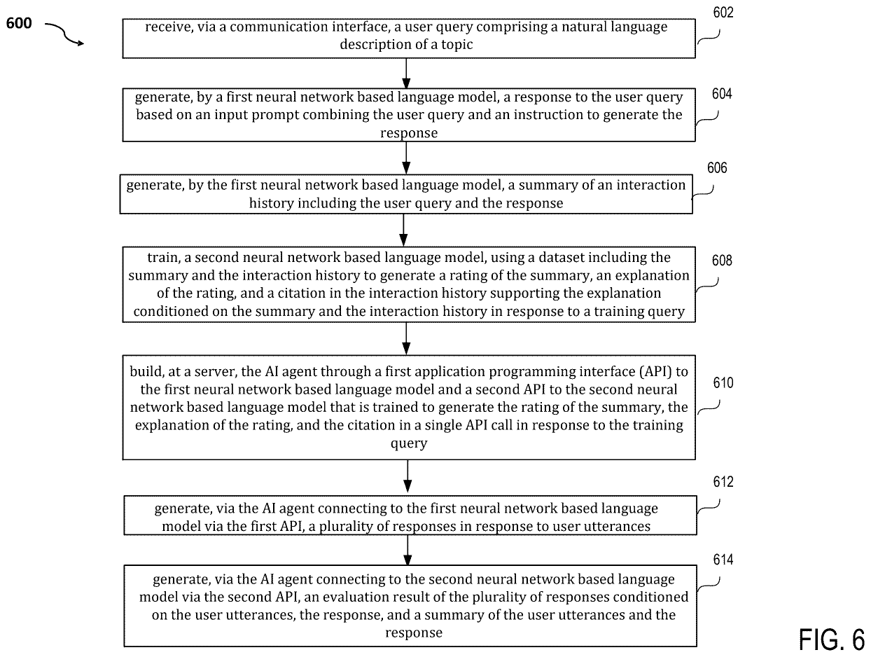

FIG. 6 is an example logic flow diagram illustrating a method of agent verification based on the framework shown in FIGS. 1, 2, 3A-3C, 4A, 4B, and 5, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the AI agent module 430 (e.g., FIGS. 4A and 5) that performs answer generation and answer evaluation.

In some embodiments, method 600 is performed by a system such as computing device 400, user device 510, server 530, or another device or combination of devices. Inputs (e.g., a user query for inference, and/or text generated by a text-generating LLM, contexts, optional task prompt, and/or a reference evaluation report for training) may be received via a data interface such as data interface 415, network interface 517, network interface 533, or via a data interface that is integrated with a device. For example, UI Application 512 may receive user inputs via a text input interface (e.g., keyboard), audio input (e.g., microphone), video interface (e.g., camera), or other interface for receiving user inputs (e.g., a mouse or touch display).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, a user query (e.g., 202) including a natural language description, e.g., of a topic, is received via a communication interface.

At step 604, a response (e.g., 212) to the user query is generated by a first neural network based language model (e.g., 206) based on an input prompt (e.g., 210) combining the user query and an instruction to generate the response.

At step 606, a summary (e.g., an example of text generation 214) of an interaction history, including the user query and the response, is generated by the first neural network based language model. In some embodiments, the interaction history includes one or more user queries, one or more retrieved documents in response to the user queries, and one or more responses generated based on the one or more retrieved documents.

At step 608, a second neural network based language model (e.g., evaluator LLM 208) is trained using a dataset including the summary and the interaction history to generate a rating of the summary, an explanation of the rating, and a citation in the interaction history supporting the explanation conditioned on the summary and the interaction history in response to a training query.

In some embodiments, the rating is generated based on a predetermined evaluation metric, which includes faithfulness, instruction following, coherence, completeness, or the citation. In some embodiments, the citation is generated in a predetermined citation mode, which includes a post-fix citation mode, a post-fix citation mode with snippet, an inline citation mode, or an inline citation mode with snippet.

In some embodiments, the dataset further comprising a reference rating of the summary, a reference explanation of the rating, and a reference citation for comparing with the rating, the explanation of the rating and the citation respectively according to a training objective for the training of the second neural network based language model.

At step 610, the AI agent is built at a server (e.g., AI agent server 204), through a first application programming interface (API) to the first neural network based language model and a second API to the second neural network based language model that is trained to generate the rating of the summary, the explanation of the rating, and the citation in a single API call in response to the training query. For example, the trained first and/or second neural network models may be deployed at a local or remote server(s), based on a hardware platform 430 described in FIG. 4B. In some implementations, the AI agent may comprise a server-client component such that a client software package may be delivered to and installed at a user device (e.g., 510 in FIG. 5). In this way, the AI agent may provide a graphic user interface to present an output to a user.

In some embodiments, the training of the second neural network based language model includes training the second neural network based language model for a pointwise evaluation task or a citation task The pointwise evaluation task may include evaluating an aspect of a response independently according to evaluation criteria and providing a rating. The citation task may include evaluation the response alongside a context, and providing citations for verifiable answer attribution.

At step 612, a plurality of responses (e.g., 212) are generated in response to user utterances generating via the AI agent connecting to the first neural network based language model via the first API.

At step 614, an evaluation result (e.g., 218) of the plurality of responses are generated via the AI agent connecting to the second neural network based language model via the second API, conditioned on the user utterances, the response, and a summary of the user utterances and the response.

In some embodiments, method 600 further includes causing, via a client component of the AI agent, an adjustment of a display of a user-system conversation at a user interface, the adjustment including removing at least one response from the display based on the evaluation result. In some embodiments, method 600 further includes updating the instruction to the first neural network based language model based on the evaluation report.

In some embodiments, method 600 is applicable in a variety of applications. AI agents built based on method 600 can be used to improve the text generation in response to user's queries. Specifically, the evaluation report can be used as feedback for the AI agents to improve the input prompts generated for the LLMs/agents. For example, the task request received by a neural network model (e.g., 106 or 202) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 600, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 600 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

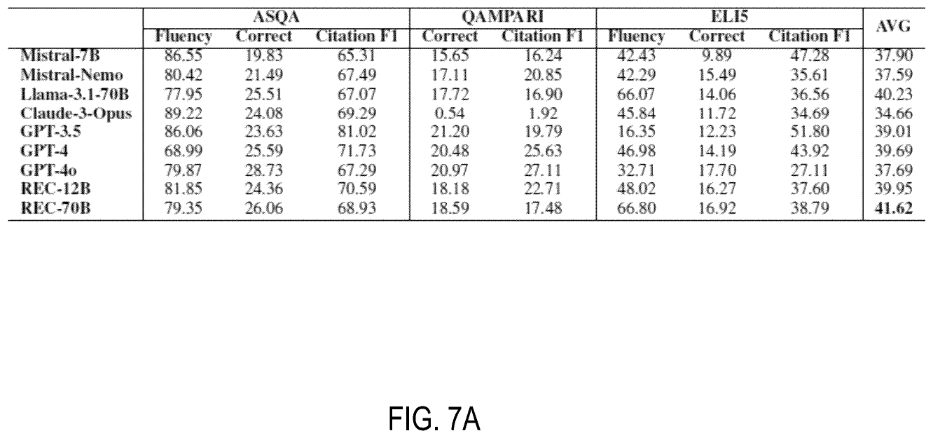

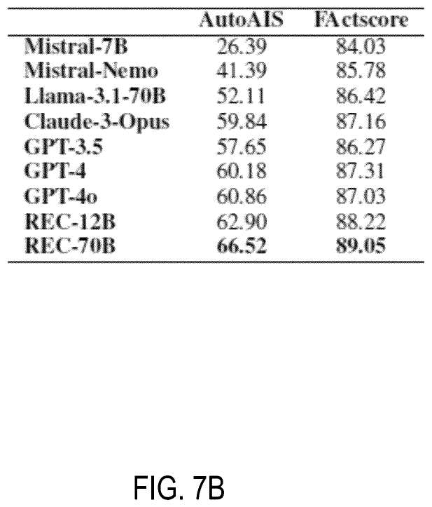

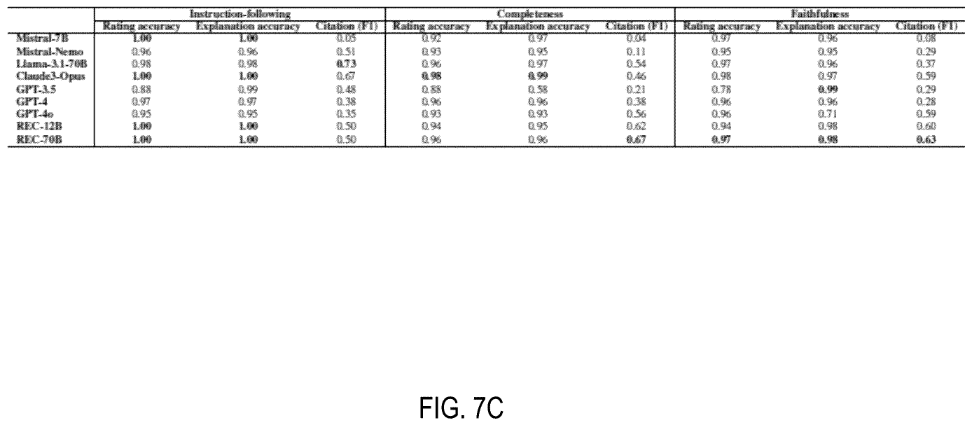

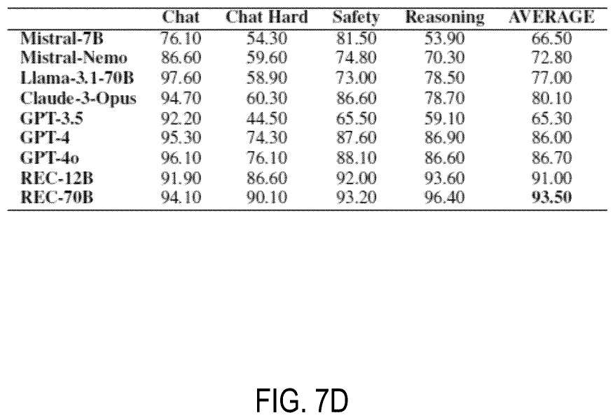

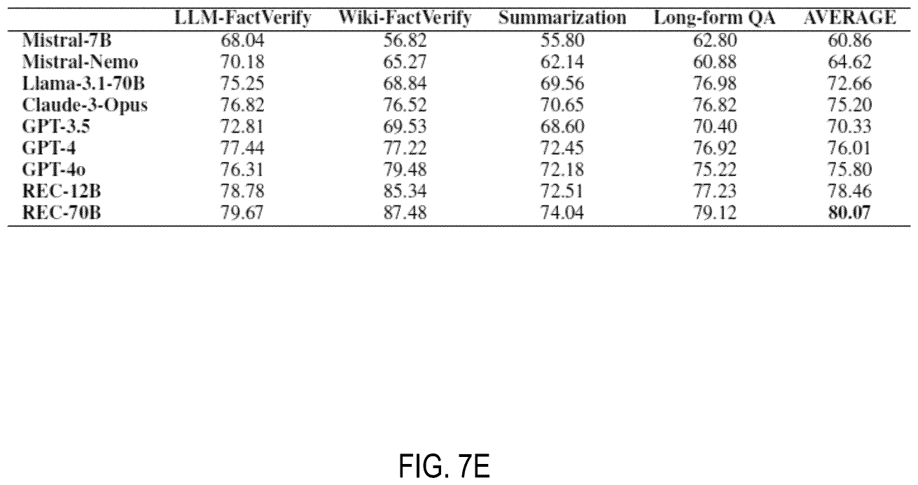

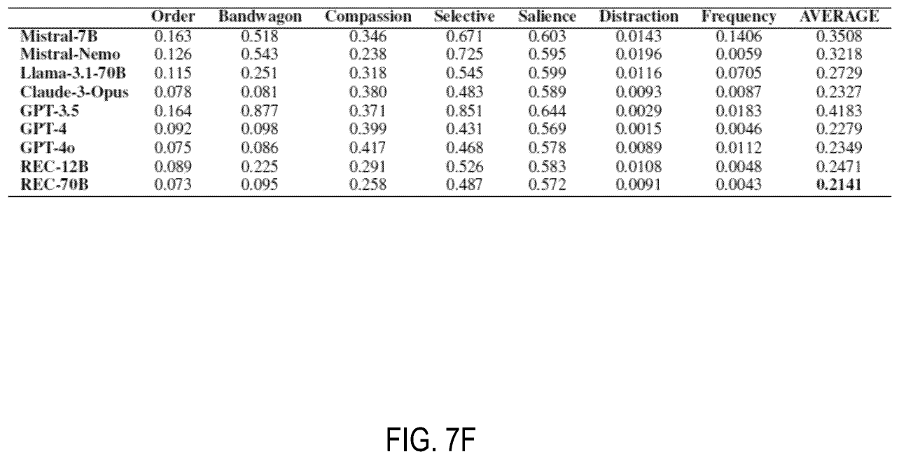

FIGS. 7a-7f represent exemplary test results using embodiments described herein.

The general-purpose LLM autoevaluator (e.g., evaluator LLM 208) that is trained is available in two sizes, and they are denoted as REC-12B and REC-70B separately. REC-12B is instruction fine-tuned from Mistral-Nemo (https://mistral.ai/news/mistral-nemo), and REC-70B is instruction fine-tuned from Llama-3.1-70B (Llama Team, 2024. The llama 3 herd of models. Preprint, arXiv:2407.21783.). Supervised fine-tuning (SFT) is adopted to optimize the models. To accommodate GPU memory constraints, the following design choices are made: examples where the combined length of the prompt and the response exceeded 6,144 tokens are filtered out. Low-Rank Adaptation (LoRA) is used during fine-tuning (Edward J. Hu, Yelong Shen, Phillip Wallis, Zeyuan Allen-Zhu, Yuanzhi Li, Shean Wang, Lu Wang, and Weizhu Chen, 2021,“Lora: Low-rank adaptation of large language models”, Preprint, arXiv:2106.09685.) with a rank of r=256 for REC-12B and r=64 for REC-70B. Additionally, 4-bit quantization is applied for REC-70B during initialization. Both models were trained using a learning rate of 1×10⁴, with data shuffled and for a single epoch. REC-12B was trained with a batch size of 2 and a gradient accumulation factor of 8, whereas for REC-70B we used a batch size of 1 with the same gradient accumulation factor. Both models were trained on eight NVIDIA H100 GPUs, each with 80 GB of memory. The total training time was approximately 4.5 hours for REC-12B and 5.5 hours for REC-70B.

The REC models are evaluated on diverse benchmarks assessing LLMs'(1) RAG citation capability: ALCE (Tianyu Gao, Howard Yen, Jiatong Yu, and Danqi Chen, 2023,“Enabling large language models to generate text with citations”, ArXiv, abs/2305.14627.), and ExpertQA (Chaitanya Malaviya, Subin Lee, Sihao Chen, Elizabeth Sieber, Mark Yatskar, and Dan Roth, 2024,“ExpertQA: Expert-curated questions and attributed answers”, In 2024 Annual Conference of the North American Chapter of the Association for Computational Linguistics); (2) content quality citation capability: human evaluation on ABCD summarization (Derek Chen, Howard Chen, Yi Yang, Alexander Lin, and Zhou Yu, 2021, “Action-based conversations dataset: A corpus for building more in-depth task-oriented dialogue systems”, In Proceedings of the 2021 Conference of the North American Chapter of the Association for Computational Linguistics: Human Language Technologies, pages 3002-3017, Online Association for Computational Linguistics.); (3) general capabilities: RewardBench (Nathan Lambert, Valentina Pyatkin, Jacob Morrison, L J Miranda, Bill Yuchen Lin, Khyathi Chandu, Nouha Dziri, Sachin Kumar, Tom Zick, Yejin Choi, Noah A. Smith, and Hannaneh Hajishirzi, 2024, “Rewardbench: Evaluating reward models for language modeling”, https://huggingface.co/spaces/allenai/reward-bench) and LLM-AggreFact (Liyan Tang, Philippe Laban, and Greg Durrett. 2024a, “Minicheck: Efficient fact-checking of llms on grounding documents”, In Proceedings of the 2024 Conference on Empirical Methods in Natural Language Processing Association for Computational Linguistics; Liyan Tang, Philippe Laban, and Greg Durrett, 2024b, “Minicheck: Efficient fact-checking of llms on grounding documents”, arXiv preprint arXiv:2404.10774.) (4) cognitive bias: CoBBLEr (Ryan Koo, Minhwa Lee, Vipul Raheja, Jong Inn Park, Zae Myung Kim, and Dongyeop Kang, 2024,“Benchmarking cognitive biases in large language models as evaluators”, In Findings of the Association for Computational Linguistics ACL 2024, pages 517-545, Bangkok, Thailand and virtual meeting, Association for Computational Linguistics), each of which is an important measure to a general-purpose LLM autoevaluator. The results are compared against 7 SOTA LLMs, including Misral-7B (Mistral-7 B-Instruct-v0.2), Mistral-Nemo (Mistral-Nemo-Instruct-2407), Llama-3.1-70B (Llama-3.1-70B), Claude-3-Opus (claude-3-opus-20240229), GPT-3.5 (gpt-3.5-turbo), GPT-4 (gpt-4-turbo), GPT-4o (gpt-4o).

RAG citation and Correctness of the models are studied. The ALCE (Automatic LLMs'Citation Evaluation) benchmark is designed to assess the ability of LLMs to generate text with accurate and relevant citations. ALCE addresses this by providing a framework that evaluates the quality of citations in text generated by LLMs, focusing on three key dimensions: fluency, correctness, and citation quality. The ALCE benchmark is built on three datasets: ASQA (a short-answer question dataset), QAMPARI (which provides lists of correct answers), and ELI5 (a long-form question-answer dataset). For each dataset, ALCE evaluates how well the model generates text that is not only fluent and accurate but also properly supported by citations. The evaluation includes metrics like citation precision (ensuring all cited sources are relevant) and citation recall (ensuring all necessary sources are cited). ALCE does not provide training data but instead measures citation performance through retrieval-based systems that simulate real-world information-seeking tasks, where the model retrieves relevant passages and uses them to support its answers. As shown in FIG. 7A, the REC models rank highly in terms of overall average performance, with REC-70B achieving an average score of 41.62, the highest among compared models, and REC-12B reaching 39.95. This highlights the robustness and balance of these models across fluency, correctness, and citation quality. REC offers a well-rounded solution across different types of questions, making it highly reliable for real-world applications where both citation quality and answer correctness are essential. Specifically, while GPT-4 excels in citation quality, the much smaller REC models outperform all the other competitors.

ExpertQA (Chaitanya Malaviya, Subin Lee, Sihao Chen, Elizabeth Sieber, Mark Yatskar, and Dan Roth, 2024,: ExpertQA: Expert-curated questions and attributed answers”, In 2024 Annual Conference of the North American Chapter of the Association for Computational Linguistics.) is designed to evaluate LLMs'ability to generate accurate and well-attributed responses in technical and high-stakes fields, such as medicine and law. It was developed by involving experts from 32 different fields, who contributed 2,177 domain-specific questions based on their knowledge. In total, 484 participants helped curate these questions. LLMs were then used to generate responses to the questions, followed by human experts evaluating the quality of these responses on several criteria, including factual correctness, completeness of attribution, source reliability, and informativeness. The metrics used in its paper are adopted: AutoAIS (Luyu Gao, Zhuyun Dai, Panupong Pasupat, Anthony Chen, Arun Tejasvi Chaganty, Yicheng Fan, Vincent Zhao, N. Lao, Hongrae Lee, Da-Cheng Juan, and Kelvin Guu, 2022, “Rarr: Researching and revising what language models say, using language models”, ArXiv, abs/2210.08726), which is similar to citation recall, and Factscore (Sewon Min, Kalpesh Krishna, Xinxi Lyu, Mike Lewis, Wen-tau Yih, Pang Koh, Mohit Iyyer, Luke Zettle-moyer, and Hannaneh Hajishirzi, 2023,“FActScore: Fine-grained atomic evaluation of factual precision in long form text generation”, In Proceedings of the 2023 Conference on Empirical Methods in Natural Language Processing, pages 12076-12100, Singapore. Association for Computational Linguistics) which measures the percentage of generated claims that are factual. Claims are generated from gold long-form answers with every compared model, and use an NLI model (Or Honovich, Roee Aharoni, Jonathan Herzig, Hagai Taitelbaum, Doron Kukliansy, Vered Cohen, Thomas Scialom, Idan Szpektor, Avinatan Hassidim, and Yossi Matias, 2022,“TRUE: Re-evaluating factual consistency evaluation”, In Proceedings of the Second DialDoc Workshop on Document-grounded Dialogue and Conversational Question Answering, pages 161175, Dublin, Ireland, Association for Computational Linguistics) to determine the attribution of claim-evidence pairs in the ExpertQA dataset.

As shown by the zero-shot results in FIG. 7B, REC-12B and REC-70B achieve the highest AutoAIS and FActscore scores, which not only indicates their best citation quality but also the generalizability of their attribution capability across domains.

Rating, Explanation, and Citation of the models are studied. To evaluate the LLM autoevaluator's citation capability more comprehensively, besides examining its general RAG citation capability on QA tasks, the content quality citation capability on a summarization task, the ABCD dataset (Derek Chen, Howard Chen, Yi Yang, Alexander Lin, and Zhou Yu, 2021,“Action-based conversations dataset: A corpus for building more in-depth task-oriented dialogue systems”, In Proceedings of the 2021 Conference of the North American Chapter of the Association for Computational Linguistics: Human Language Technologies, pages 3002-3017, Online. Association for Computational Linguistics.), are evaluated.

The ABCD dataset contains customer support conversation transcripts. Summaries are generated by prompting Mistral-7B (Albert Qiaochu Jiang, Alexandre Sablayrolles, Arthur Mensch, Chris Bamford, Devendra Singh Chaplot, Diego de Las Casas, Florian Bressand, Gianna Lengyel, Guillaume Lample, Lucile Saulnier, L'elio Renard Lavaud, Marie-Anne Lachaux, Pierre Stock, Teven Le Scao, Thibaut Lavril, Thomas Wang, Timothee Lacroix, and William El Sayed, 2023, Mistral 7b. ArXiv, abs/2310.06825) with: “Summarize knowledge from transcripts after they've ended, including the customer issue and resolution.” to form (dialogue, summary) pairs for evaluation. LLM autoevaluators then take as input the summarization task prompt hydrated with the dialogue, and the summary, to generate rating, explanation, and citations according to metrics defined in this disclosure. It is noted that a held-out set of 50 examples are used in this experiment to make sure there exists no data overlap with the ABCD subsets used during training. However, unlike all the other evaluations included in this paper, this evaluation is in-distribution.

Different from the general RAG citation benchmarks, which contain human annotated citation groundtruth, there exists no well-established benchmarks to evaluate content quality citations. Hence, human annotations are sought to serve as a reference standard in this task. The final citation outputs were labeled by 12 machine learning experts where each has a graduate degree in computer science or related fields. They were asked to complete three tasks: rating correctness evaluation, explanation correctness evaluation, and to provide manually-written citations for the claims in explanation.

Two labelers are assigned for each model and the average inter-rater agreement is found is around 95%. For the correctness of rating and explanation, it is reported that average results of the two labels, while for citations, the intersection of the results of the two labelers are evaluated against the machine-generated citations to compute F1 score as shown in FIG. 7C. Due to the high quality summary generated by the summarizer LLM, most LLM autoevaluators obtain high rating and explanation accuracy. As for the citation task, both REC-12B and REC-70B models consistently outperform other models in F1 score.

The General Capabilities of the models are studied. The RewardBench dataset assesses LLMs'performance across several critical abilities using curated chosen-rejected response pairs (Nathan Lambert, Valentina Pyatkin, Jacob Morrison, LJ Miranda, Bill Yuchen Lin, Khyathi Chandu, Nouha Dziri, Sachin Kumar, Tom Zick, Yejin Choi, Noah A. Smith, and Hannaneh Hajishirzi, 2024, “Rewardbench: Evaluating reward models for language modeling”, https://huggingface.co/spaces/allenai/reward-bench). The evaluation process involves determining the model's win percentage based on its ability to score the “chosen” response higher than the “rejected” one. Specifically, it's focused on testing chat performance, safety measures, and reasoning (both in terms of code and math skills), while controlling for potential biases such as overfitting to prior datasets.

First, prompts following the RewardBench evaluation format are created, where each prompt consisting of a query and two potential responses. The task for LLM is to evaluate these responses and determine which one is better. The performance of the reward models is quantified by calculating the win percentage for chosen-rejected pairs associated with each prompt. A “win” is defined by a scenario where the LLM presents a preference for the selected answer. This quantitative measure provides a clear benchmark for evaluating model performance across tasks. By averaging the results across the 4 core sections: Chat, Chat Hard, Safety, and Reasoning, a comprehensive measure of each model's win percentage is derived. REC-12B achieves SOTA performance among all generative LLM with fewer than 20 billion parameters on the RewardBench leaderboard by Oct. 15, 2024, while REC-70B achieves SOTA among all generative LLMs within the RewardBench Leaderboard by Oct. 15, 2024 as shown in FIG. 7D.

LLM-AggreFact is a benchmark for measuring the grounding capabilities of autoevaluators. Given a reference document and a claim, the autoevaluator determines if the claim is fully supported by the document. This holistic benchmark combines 10 attribution datasets used in recent studies on LLM factuality. FIG. 7E presents the attribution results of this disclosure on LLM-AggreFact (Liyan Tang, Philippe Laban, and Greg Durrett, 2024a, “Minicheck: Efficient fact-checking of llms on grounding documents”, In Proceedings of the 2024 Conference on Empirical Methods in Natural Language Processing. Association for Computational Linguistics; Liyan Tang, Philippe Laban, and Greg Durrett. 2024b, “Minicheck: Efficient fact-checking of llms on grounding documents”, arXiv preprint arXiv: 2404.10774), categorized into four common use-cases: (1) LLM-FactVerify: fact verification of LLM-generated responses, (2) Wiki-FactVerify: evaluating correctness of Wikipedia claims, (3) Summarization: assessing faithfulness of summaries, and (4) Long-form QA: evaluating long-form answers to questions. The proposed model REC-70B outperforms all other models in all four categories. REC-70B achieves the highest overall average performance of 80.07, while the next-best baseline model REC-12B obtains a score of 78.46. In long-form QA attribution evaluation, REC-70B model outperforms GPT-4 (80.07 vs 76.01), demonstrating its strong performance across all categories.

Given some of the models like GPT-3.5 have lower context windows, examples longer than 16K tiktoken tokens are removed from the evaluation. Same prompt instructions are used across categories. To reduce model API costs, 256 examples per evaluation task similar to the approach used in the FLAMe (Tu Vu, Kalpesh Krishna, Salaheddin Alzubi, Chris Tar, Manaal Faruqui, and Yun-Hsuan Sung, 2024b, “Foundational autoraters: Taming large language models for better automatic evaluation”, arXiv preprint arXiv: 2407.10817) are randomly sampled.

Bias Testing of the models are conducted. Recent studies have found that LLM-as-a-Judge often exhibits cognitive biases, such as preferences for verbosity, egocentrism, bandwagon, and an overly authoritative tone (Peiyi Wang, Lei Li, Liang Chen, Zefan Cai, Dawei Zhu, Binghuai Lin, Yunbo Cao, Lingpeng Kong, Qi Liu, Tianyu Liu, and Zhifang Sui, 2024a,“Large language models are not fair evaluators”, In Proceedings of the 62nd Annual Meeting of the Association for Computational Linguistics (Volume 1: Long Papers), pages 9440-9450, Bangkok, Thailand. Association for Computational Linguistics; Ryan Koo, Minhwa Lee, Vipul Raheja, Jong Inn Park, Zae Myung Kim, and Dongyeop Kang, 2024,“Benchmarking cognitive biases in large language models as evaluators”, In Findings of the Association for Computational Linguistics ACL 2024, pages 517-545, Bangkok, Thailand and virtual meeting. Association for Computational Linguistics; Lianmin Zheng, Wei-Lin Chiang, Ying Sheng, Siyuan Zhuang, Zhanghao Wu, Yonghao Zhuang, Zi Lin, Zhuohan Li, Dacheng Li, Eric P. Xing, Hao Zhang, Joseph E. Gonzalez, and Ion Stoica, 2024, “Judging llm-as-a-judge with mt-bench and chatbot arena”, In Proceedings of the 37th International Conference on Neural Information Processing Systems, NIPS '23, Red Hook, NY, USA. Curran Associates Inc; Guiming Hardy Chen, Shunian Chen, Ziche Liu, Feng Jiang, and Benyou Wang. 2024, “Humans or llms as the judge? a study on judgement biases”, ArXiv, abs/2402.10669.) To investigate the biases of the compared models, they are evaluated on the CoBBLEr benchmark (Cognitive Bias Benchmark for LLMs as EvaluatoRs) (Ryan Koo, Minhwa Lee, Vipul Raheja, Jong Inn Park, Zae Myung Kim, and Dongyeop Kang, 2024,“Benchmarking cognitive biases in large language models as evaluators”, In Findings of the Association for Computational Linguistics ACL 2024, pages 517-545, Bangkok, Thailand and virtual meeting. Association for Computational Linguistics). This dataset is designed to evaluate the quality and reliability of LLMs when used as automated evaluators in a question-answering (QA) setting. It assesses the presence of six cognitive biases, both implicit and induced, when LLMs are tasked with ranking responses generated by various other models. CoBBLEr's core objective is to identify the extent of bias in LLM evaluation outputs.

The CoBBLEr dataset includes 50 QA instructions, randomly selected from two well-established benchmarks: BIG-bench (BIG bench authors, 2023, “Beyond the imitation game: Quantifying and extrapolating the capabilities of language models”, Transactions on Machine Learning Research.) and ELI5 (Angela Fan, Yacine Jernite, Ethan Perez, David Grang-ier, Jason Weston, and Michael Auli, 2019,“ELI5: Long form question answering”, In Proceedings of the 57th Annual Meeting of the Association for Computational Linguistics, pages 3558-3567, Florence, Italy. Association for Computational Linguistics). 16 LLMs, both open and closed-source models, generate responses to these instructions. The evaluations involve pairwise comparisons between the responses of two models, wherein each model also acts as an evaluator to rank its own and others'outputs. The biases tested are categorized into two groups: (1) Implicit biases, such as egocentric bias (where a model tends to prefer its own outputs), and (2) Induced biases, such as order bias, where the ranking of responses is influenced by their order in the evaluation.

FIG. 7F presents the performance of the compared models on the CoBBLEr benchmark with metrics of order bias, bandwagon effect, compassion, selective bias, salience, distraction, and frequency. Note that lower scores indicates better performance (e.g., fewer biases) on CoBBLEr. Overall, REC-70B model has the best average performance with a score of 0.2141, followed closely by GPT-4 (0.2279) and GPT-4o (0.2349). REC-12B, on the other hand, outperforms all the other same-sized and smaller models (Mistral-Nemo and Mistral-7B), and even some larger models (Llama-3-70B and GPT-3.5). The results suggests that training with REC leads to fewer cognitive biases and more consistent evaluation capabilities. In contrast, off-the-shelf LLMs can be more influenced by factors such as the order of responses or the length of the text.

The evaluator LLM in an agent verification framework may be trained on an expanded set of training data (described below), and be used to provide real-time feedback to improve an agent's response to an end user. The training data may include system-level parameters. In some embodiments, the agent verification framework (e.g., 200) may include the following components: an agent LLM (e.g., LLM 206), a guardrails LLM (e.g., evaluator LLM 208), an evaluation metrics module, an agent configuration updater, and a reflection loop trigger. The agent LLM may be configured to execute user requests using pre-configured tools and policies when receiving input prompts of a desired format. The evaluator LLM may be an independent LLM model that checks the agent LLM's outputs using rich input context and reasoning. The evaluator LLM may be used for enforcement and optimization, allowing the agent LLM to evolve safely without compounding its own errors. The evaluation metrics module may define structured dimensions such as completeness, factuality, groundedness, policy adherence, and task resolution, etc. These evaluation metrics are important in the reflection loop because they may provide objective, structured checkpoints that guide each iteration toward resolving specific deficiencies, ensuring the agent LLM can improve systematically rather than relying on vague or subjective feedback. The agent configuration updater may modify the input prompt to the agent LLM or flow graph in response to guardrails feedback. The reflection loop trigger may iteratively rerun the agent LLM with updates until all guardrail checks are passed.

The evaluator LLM can be applied to generate real-time feedback using a set of evaluation metrics. When the text-generating LLM generates an answer to a user query, the evaluator LLM evaluates the answer by generating a rating and an explanation, and determines whether it passes the set of evaluation metrics. If the answer fails one or more evaluation metrics, the evaluation LLM may cause the text-generating LLM to adjust and re-generate an updated answer, which is evaluated again by the evaluator LLM. Within a predetermined iteration time or number, the updated answer can be used as the final answer for the user if it passes all evaluation metrics and is approved by the evaluator LLM, or it can be sent to a human for escalation by the evaluator LLM.

In some embodiments, inputs for the evaluator LLM may include user query, multi-turn conversation history, tool usage history, policy instructions, and/or user feedback. In some embodiments, before inference, the evaluator LLM may be trained using a set of training data (e.g., an expanded set of training data) that includes a plurality of training data samples that include: task instructions, functions/tools available to the agent LLM, function calls the agent LLM made, conversation history, input prompt (e.g., including user input), and/or the agent LLM's response. The task instructions may include instructions given to the agent LLM by the agent administrator on how to handle various situations. The functions/tools available to the agent LLM may include a set of functions that the agent LLM has access to act on and solve user requests. The function calls the agent LLM made may include the set of functions that the agent LLM selects and executes to fulfil user requests out of the functions available. The conversation history may include the history of user-agent conversations in the current session. In some embodiments, the conversation history may include a multi-turn conversation history. The input prompt may include the query an end user enters when interacting with an agent. In some embodiments, the input prompt may also include various instructions combined with the user query as well as different templates that the user query is included in the input prompt. The agent LLM's response may include the final output the agent LLM provides to the end user. The evaluator LLM may be trained to generate the evaluator results (e.g., evaluator report 218) that includes two fields (i.e., rating and explanation), which collectively provide a rating of task completeness. An example of the output format includes:
a. Rating: This field indicates the resolution status, categorized as “Fully Resolved,” “Mostly Resolved,” “Partially Resolved,” or “Unresolved.”
b. Explanation: This field provides the reasoning behind the assigned rating.

The disclosed agent verification framework may be architecturally distinct and purpose-built for reasoning-based critique. The framework may ensure impartial evaluations, explainable guardrail feedback, and richer model oversight. The reflection loop performed by the agent verification framework may include the following steps. First, the agent LLM performs an initial generation to generate an output. Second, the evaluator LLM (or guardrails LLM) may receive all context and evaluates the response. Third, the evaluator LLM may output metrics, reasoning, and actionable suggestions. Then, the agent LLM's configuration may be updated to address the identified issues. Further, the improved/updated agent LLM may reattempt the task and may re-generate the output. Further, the framework may determine approval or escalation. In some embodiments, the framework may continue the loop until success or recommend human handoff as escalation. An example of the evaluation metrics to be used for the agent LLM to self-adjust/update is shown below.

```
{
  “evaluation”: {
    “TaskResolution”: {
      “value”: 3,
      explanation”: “The response addressed the user's main question with steps but missed
covering one requested sub-item.”,
    “citation”: null
    },
    “Completeness”: {
      “value”: 2,
      “explanation”: “The user requested three strategies with statistics, but the response only
contained two without numerical backing.”,
      “citation”: null
    },
    “Factuality”: {
      “value”: 4,
      “explanation”: “All statements in the response matched internal product documentation.”
      “citation”: “Internal Product Launch Record, DocID: PRD-2020-045”
    },
    “Groundedness”: {
      “value”: 3,
      “explanation”: “Most claims are supported by survey data, but one recommendation lacked
explicit citation.”,
      “citation”: “Customer Survey Report Q2 2025, SheetID: SUR-2025-Q2”
    },
    “Coherence”: {
      “value”: 4,
      explanation”: “The reasoning flows logically and reads fluently without abrupt
transitions.”,
      “citation”: null
    },
    “PolicyAdherence”: {
      “value”: 4,
      explanation”: “No violations of competitor-name restrictions or compliance policies were
detected.”,
      “citation”: “Policy Reference: LEG-2024-Compliance”
    }
  }
}
```

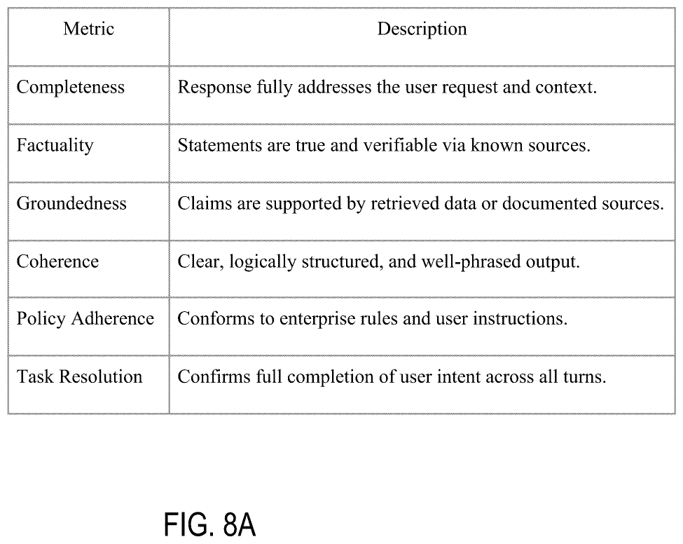

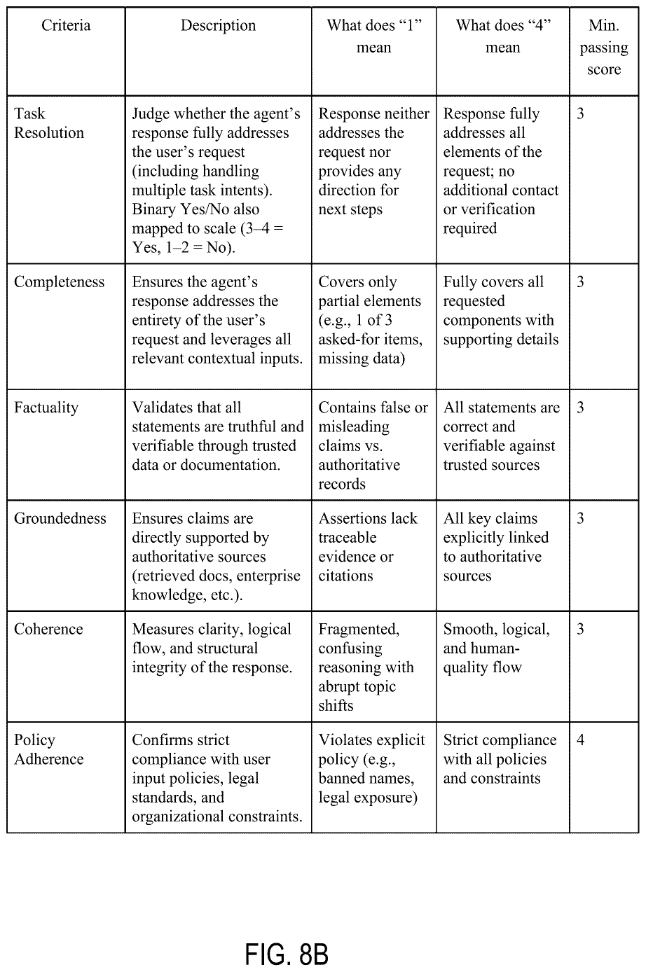

Each output by the agent LLM may be assessed with a reasoned explanation, and structured feedback is used to guide regeneration or escalation. The evaluation metrics module may serve as the quotative and qualitative backbone of the reflection loop. Each metric operates both as a diagnostic tool—pinpointing deficiencies in a given response—and as a guiding compass—indicating the exact improvements needed in subsequent regeneration attempts. In some embodiments, the evaluator LLM may generate the evaluation results, e.g., included in an evaluation report (e.g., 218). FIG. 8A shows evaluation metrics used in generating the evaluation results, and their corresponding description.
Completeness. The purpose of the completeness metric may include ensuring that the agent LLM's response addresses the entirety of the user's request and leverages all relevant contextual inputs. For example, if a user asks for “three strategies and supporting statistics,” a response containing only two strategies, without numerical backing, may be flagged as incomplete based on the completeness metric. In some embodiments, missing components may trigger explicit instructions in the next run. For example, the instructions may include “Include third strategy with cited data”.
Factuality: The purpose of the factuality metric may include validating that all statements are truthful and verifiable through trusted data or documentation. For example, if the agent states that “Product X launched in 2018” but internal records confirm a 2020 launch, the evaluator logs a factuality violation. In some embodiments, input prompts may be adjusted to reinforce retrieval-based grounding before regeneration. Groundedness. The purpose of the groundedness metric may include ensuring that claims are directly supported by authoritative sources, whether retrieved via integrated tools or embedded enterprise knowledge. For example, a recommendation “based on recent customer surveys” must be traceable to actual survey data; otherwise, it is marked as insufficiently grounded. In some embodiments, the agent LLM may be reconfigured to increase evidence citation density and enforce source linking.
Coherence. The purpose of the coherence metric may include measuring clarity, logical flow, and structural integrity of the output, ensuring the output reads as a well-constructed, human-quality response. For example, a response containing fragmented reasoning or abrupt topic shifts would fail coherence checks. In some embodiments, evaluator LLM may suggest re-sequencing information and simplifying sentence construction.
Policy adherence. The purpose of the policy adherence metric may confirm strict compliance with user's input policies, legal standards, and custom user constraints, etc. For example, if a policy prohibits mentioning specific competitor names, any violation may result in a block and/or escalation. In some embodiments, injection of explicit “do-not” policy reminders into prompt preamble.
Task Resolution. The purpose of the task resolution may determine whether the user's original goal—across potentially multiple conversation turns—has been fully satisfied. For example, if the task is to “generate and email a proposal,” generating the proposal alone without confirming email delivery would be flagged as unresolved. In some embodiments, the agent LLM may receive state-tracking directives to verify all action completions.

FIG. 8B shows the criteria used by the evaluator LLM to generate scores for the agent LLM's outputs, and the minimum passing score for each criterium. For example, if the score is below any minimum passing score, the evaluator LLM may determine the output as “failed” or “no passing”, and may provide feedback to the agent LLM to update the output. In some embodiments, the framework may undergo a plurality of different phases to generate the final output for a task. At the evaluation phase, after an initial generation, the evaluator LLM may assign scores, provide natural-language justifications, and identify failure points. At the update phase, the agent LLM's configuration updater may adjust prompt templates, retrieval depth, and/or reasoning steps based on metric-level feedback. At the re-generation phase: the adjusted/updated agent LLM may attempt the task again, aiming to elevate all metrics above predefined thresholds. At the escalation phase, if repeated iterations fail to meet minimum standards, the output of the agent LLM is routed to auto-optimization or human review/handover.

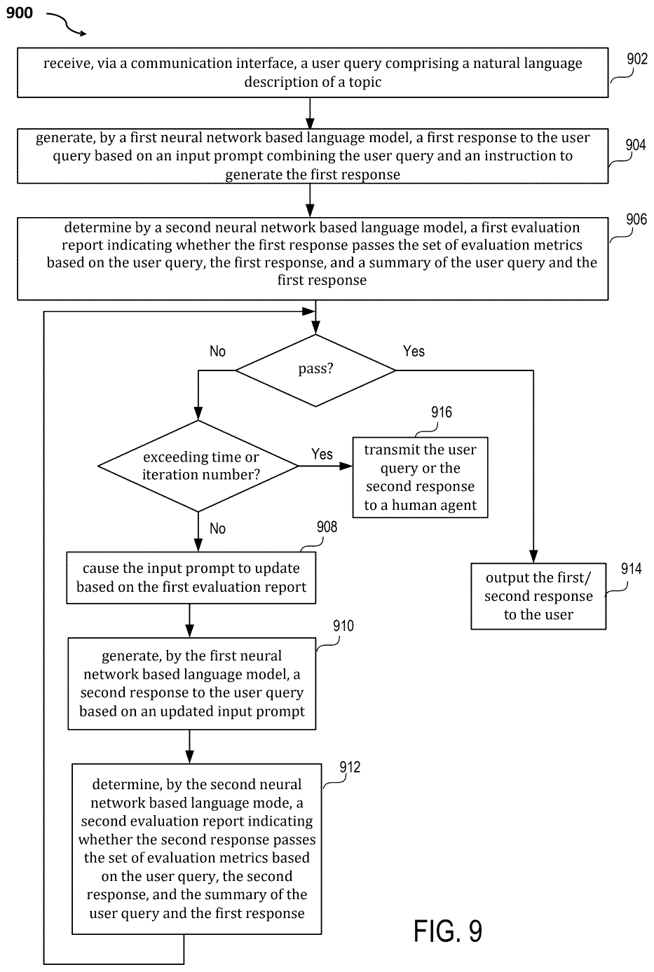

FIG. 9 is an example logic flow diagram illustrating a method of agent verification based on the framework shown in FIGS. 1, 2, 3A-3C, 4A, 4B, 5, 8A-8B, according to some embodiments described herein. One or more of the processes of method 900 may be implemented, at least in part, in the form of executable code stored on non-transitory, tangible, machine-readable media that when run by one or more processors may cause the one or more processors to perform one or more of the processes. In some embodiments, method 900 corresponds to the operation of the AI agent module 430 (e.g., FIGS. 4A and 5) that performs answer generation and answer evaluation.

In some embodiments, method 900 is performed by a system such as computing device 400, user device 510, server 530, or another device or combination of devices. Inputs (e.g., a user query for inference, and/or text generated by a text-generating LLM, contexts, optional task prompt, and/or a reference evaluation report for training) may be received via a data interface such as data interface 415, network interface 517, network interface 533, or via a data interface that is integrated with a device. For example, UI Application 512 may receive user inputs via a text input interface (e.g., keyboard), audio input (e.g., microphone), video interface (e.g., camera), or other interface for receiving user inputs (e.g., a mouse or touch display).

As illustrated, the method 900 includes a number of enumerated steps, but aspects of the method 900 may include additional steps before, after, and in between the enumerated steps. In some aspects, one or more of the enumerated steps may be omitted or performed in a different order.

At step 902, a user query including a natural language description of a topic is received via a communication interface.

At step 904, a first response to the user query is generated, by a first neural network based language model, based on an input prompt combining the user query and an instruction to generate the first response.

At step 906, a first evaluation report indicating whether the first response passes the set of evaluation metrics is determined, by a second neural network based language model, based on the user query, the first response, and a summary of the user query and the first response.

In some embodiments, the first evaluation report is generated in real time. wherein the first evaluation report includes a rating of the first response and an explanation of the rating.

In some embodiments, the set of evaluation metrics include completeness, factuality, groundedness, coherence, policy adherence, or a task resolution, each of the evaluation metrics having a respective range for pass or fail.

In some embodiments, the second neural network based language model is trained based on a set of training data that includes one or more of a training task instruction, a training function available to the first neural network based language model, a training function call made by the first neural network based language model, a training conversation history, an input prompt, or a training final output of the first neural network based language model.

At step 908, in response to the first response failing to pass at least one evaluation metric of the set of evaluation metrics, the input prompt is caused to update based on the first evaluation report.

In some embodiments, the method further includes, in response to the first response failing to pass at least one evaluation metric of the set of evaluation metrics, causing a retrieval depth or reasoning steps to update based on the first evaluation report.

At step 910, a second response to the user query is generated, by the first neural network based language model, based on an updated input prompt.

At step 912, a second evaluation report indicating whether the second response passes the set of evaluation metrics is determined, by the second neural network based language mode, based on the user query, the second response, and the summary of the user query and the first response.

At step 914, in response to the first response and/or the second response passing the set of evaluation metrics, the second response is outputted to the user.

In some embodiments, it is determined whether the second response failing at least one of the set of evaluation metrics after a predetermined time period of iteration number. At step 916, in response to the second response failing at least one of the set of evaluation metrics after a predetermined time period of iteration number, transmitting the user query or the second response to a human agent. If no, method 900 proceeds to step 908.

The disclosed framework may have improved auditability and the ability for continuous learning. All metric assessments, explanations, and scoring histories are logged in a persistent audit trail. This serves dual purposes such as compliance & traceability, and model improvement. Compliance & traceability may be used to provide proof of why a response passed or failed at a given time. Model Improvement may locate patterns in metric failures such that fine-tuning datasets can be informed and policy refinement can be performed.

The disclosed framework may have several benefits. First, unbiased evaluation can be obtained. The evaluator LLM may, y independent and impartial. Second, enterprise compliance can be obtained. Dynamic policy enforcement can be implemented through natural language constraints. Automated remediation can be obtained. Outputs can be fixed without requiring manual review. Further, The framework may gain user trust. Outputs by the agent LLM may be safer, clearer, and more complete. Further, modularity can be obtained. Components may be upgradeable and compatible with existing LLM configuration.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of configuring an artificial intelligence (AI) agent to respond to a user query, comprising:
receiving, via a communication interface, a user query comprising a natural language description of a topic;
generating, by a first neural network based language model, a first response to the user query based on an input prompt combining the user query and an instruction to generate the first response;
determining by a second neural network based language model, a first evaluation report indicating whether the first response passes the set of evaluation metrics based on the user query, the first response, and a summary of the user query and the first response;
in response to the first response failing to pass at least one evaluation metric of the set of evaluation metrics, causing the input prompt to update based on the first evaluation report;
generating, by the first neural network based language model, a second response to the user query based on an updated input prompt;
determining, by the second neural network based language mode, a second evaluation report indicating whether the second response passes the set of evaluation metrics based on the user query, the second response, and the summary of the user query and the first response;
in response to the second response passing the set of evaluation metrics, outputting the second response to the user.

2. The method of claim 1, further comprising, in response to the first response failing to pass at least one evaluation metric of the set of evaluation metrics, causing a retrieval depth or reasoning steps to update based on the first evaluation report.

3. The method of claim 1, wherein the first evaluation report is generated in real time.

4. The method of claim 1, wherein the second neural network based language model is trained based on a set of training data that includes one or more of a training task instruction, a training function available to the first neural network based language model, a training function call made by the first neural network based language model, a training conversation history, an input prompt, or a training final output of the first neural network based language model.

5. The method of claim 1, wherein the first evaluation report includes a rating of the first response and an explanation of the rating.

6. The method of claim 1, wherein the set of evaluation metrics include completeness, factuality, groundedness, coherence, policy adherence, or a task resolution, each of the evaluation metrics having a respective range for pass or fail.

7. The method of claim 1, in response to the second response failing at least one of the set of evaluation metrics after a predetermined time period of iteration number, transmitting the user query or the second response to a human agent.

8. A system for configuring an artificial intelligence (AI) agent to respond to a user query, the system comprising:
a memory that stores a first neural network based language model, a second neural network based language model, and a plurality of processor executable instructions;
a communication interface that receives a user query comprising a natural language description of a topic; and
one or more hardware processors that read and execute the plurality of processor-executable instructions from the memory to perform operations comprising:
generating, by a first neural network based language model, a first response to the user query based on an input prompt combining the user query and an instruction to generate the first response;
determining by a second neural network based language model, a first evaluation report indicating whether the first response passes the set of evaluation metrics based on the user query, the first response, and a summary of the user query and the first response;
in response to the first response failing to pass at least one evaluation metric of the set of evaluation metrics, causing the input prompt to update based on the first evaluation report;
generating, by the first neural network based language model, a second response to the user query based on an updated input prompt;
determining, by the second neural network based language mode, a second evaluation report indicating whether the second response passes the set of evaluation metrics based on the user query, the second response, and the summary of the user query and the first response;
in response to the second response passing the set of evaluation metrics, outputting the second response to the user.

9. The system of claim 8, further comprising, in response to the first response failing to pass at least one evaluation metric of the set of evaluation metrics, causing a retrieval depth or reasoning steps to update based on the first evaluation report.

10. The system of claim 8, wherein the first evaluation report is generated in real time.

11. The system of claim 8, wherein the second neural network based language model is trained based on a set of training data that includes one or more of a training task instruction, a training function available to the first neural network based language model, a training function call made by the first neural network based language model, a training conversation history, an input prompt, or a training final output of the first neural network based language model.

12. The system of claim 8, wherein the first evaluation report includes a rating of the first response and an explanation of the rating.

13. The system of claim 8, wherein the set of evaluation metrics include completeness, factuality, groundedness, coherence, policy adherence, or a task resolution, each of the evaluation metrics having a respective range for pass or fail.

14. The system of claim 8, in response to the second response failing at least one of the set of evaluation metrics after a predetermined time period of iteration number, transmitting the user query or the second response to a human agent.

15. A non-transitory machine-readable medium comprising a plurality of machine-executable instructions which, when executed by one or more processors, are adapted to cause the one or more processors to perform operations comprising:
receiving, via a communication interface, a user query comprising a natural language description of a topic;
generating, by a first neural network based language model, a first response to the user query based on an input prompt combining the user query and an instruction to generate the first response;
determining by a second neural network based language model, a first evaluation report indicating whether the first response passes the set of evaluation metrics based on the user query, the first response, and a summary of the user query and the first response;
in response to the first response failing to pass at least one evaluation metric of the set of evaluation metrics, causing the input prompt to update based on the first evaluation report;
generating, by the first neural network based language model, a second response to the user query based on an updated input prompt;
determining, by the second neural network based language mode, a second evaluation report indicating whether the second response passes the set of evaluation metrics based on the user query, the second response, and the summary of the user query and the first response;
in response to the second response passing the set of evaluation metrics, outputting the second response to the user.

16. The non-transitory machine-readable medium of claim 15, further comprising, in response to the first response failing to pass at least one evaluation metric of the set of evaluation metrics, causing a retrieval depth or reasoning steps to update based on the first evaluation report.

17. The non-transitory machine-readable medium of claim 15, wherein the first evaluation report is generated in real time.

18. The non-transitory machine-readable medium of claim 15, wherein the second neural network based language model is trained based on a set of training data that includes one or more of a training task instruction, a training function available to the first neural network based language model, a training function call made by the first neural network based language model, a training conversation history, an input prompt, or a training final output of the first neural network based language model.

19. The non-transitory machine-readable medium of claim 15, wherein the first evaluation report includes a rating of the first response and an explanation of the rating.

20. The non-transitory machine-readable medium of claim 15, wherein the set of evaluation metrics include completeness, factuality, groundedness, coherence, policy adherence, or a task resolution, each of the evaluation metrics having a respective range for pass or fail.
